(19) United States
(12) Patent Application Publication
(10) Pub. No.: US 2003/0061211 A1
(43) Pub. Date: Mar. 27, 2003

(54) GIS based search engine

(76) Inventors: Troy L. Shultz, Stow, OH (US); Anthony A. Romito, Uniontown, OH (US); Brett A. Urian, Wooster, OH (US)

Correspondence Address: Squire, Sanders & Dempsey L.L.P., Two Renaissance Square, Suite 2700, 40 N. Central Avenue, Phoenix, AZ, 85004-4498, US

(21) Appl. No.: 10/286,187

(22) Filed: Nov. 1, 2002

Related U.S. Application Data
(63) Continuation of application No. 09/896,602, filed on Jun. 29, 2001.
(60) Provisional application No. 60/215,635, filed on Jun. 30, 2000.
(60) Provisional application No. 60/224,430, filed on Aug. 11, 2000.

(51) Int. Cl. G06F 7/00

(52) U.S. Cl. 707/3

(57) ABSTRACT

The present invention provides for a global computer network geographic information system (GIS) based search engine. The GIS search engine correlates entities and relevant information, such as its products and services, to a record in the database of the GIS search system that corresponds to a unique geographic location. This correlation enables search results to be directed in a user defined geographic criteria. Additionally, the GIS based search engine can be combined with advertising information to geographically target advertising over the Internet. Geographically defined search results may include the name, phone number, and/or address of an entity as well as additional information about the entity, including one or more entity locations on a user displayed map. Further, information, such as advertisements, for the GIS based search engine can be updated by remote entities by uploading information over the Internet to the database used by the GIS based search engine.

### CROSS-REFERENCE TO RELATED APPLICATIONS

This application is a continuing application under 35 U.S.C. §1.53(b) of copending U.S. application Ser. No. 09/896,602 to the same inventors and filed on Jun. 29, 2001, which claims benefit of priority under 35 U.S.C. §119(e) from respective U.S. Application Serial No. 60/215,635, filed on Jun. 30, 2000, entitled Geo-coded search engine; and No. 60/224,430 filed on Aug. 11, 2000, entitled IGIS Based Internet Search Engine, Dynamic Advertising and Commerce Platform. The priority applications are hereby incorporated herein by their reference.

### BACKGROUND OF THE INVENTION

1. Technical Field

This invention pertains to the field of search engines and more specifically to a GIS (Geographic Information System) based search engine.

2. Background Art

With the increasing popularity of the Internet and the World Wide Web, it is common for both business and individuals (i.e. users) to utilize on-line search engines, such as Yahoo, Excite, Dogpile, Google, and Infoseek, to search for business related information. For example, users often use these search engines to look for a business that provides a particular product or service that is close to their location. Thus, the user will use the search engine to search for the particular product or service in the hopes of finding a desired business close to their location.

Unfortunately, these search engines often return a wide range of unusable search results, for example, search results relating to regional, national or, even, international entities. Thus, the conventional search engines often find businesses and other types of sought entities that are located in areas far outside of what may be practical to the user.

Further, these search engines can only search for businesses that have active web pages, news, or advertising or other types of listings that may be found by web crawlers or otherwise published on the Internet. As such, the user must often utilize and a conventional reference manual, such as business-to-business yellow pages or regional yellow pages to find the business information they are searching for. However, these traditional references neither provide information on how far each business is from a desired location or area nor do they provide information on whether or not there is another business or entity that is closer to the user's desired location. In addition, these traditional references do not have any capability for dynamic or real time advertising.

Some conventional search engines enable users to search by a predefined or “canned” geographic region, such as a city, country or zip code region. Unfortunately, the search results for these search engines are not very specific. For example, these search engines would not provide information on a business that might be closer to the user, but outside the “canned” geographic region. Further, many users may know the geographic area they want to search but not the best name or way to reference the desired geographic region or the best key words to search by. Some users, such as those users who have recently moved into an area or travelers, may not know which “canned” geographic region to search in. Thus, what is needed is a search engine that can search by a specific, user-defined geographic area, such as a property address, latitude and longitude, or any unified geocoding system. Geocoding generally pertains to assigning a map position to an address record.

The present invention provides for an network accessible geographic information system (GIS) based search engine. The GIS search engine utilizes a geographic information system, or GIS, to extend the functionality of traditional databases by combining spatial features with information records. A GIS is a computer system capable of assembling, storing, manipulating, and displaying geographically referenced information, i.e. data identified according to their locations. GIS is unique because maps and other data can be stored or filed as layers of information. Using GIS makes it possible to perform complex analyses. The GIS-based search engine of the present invention may correlate a business and its relevant information, such as its products and services, to a record in the database of the GIS system that corresponds to a unique geographical location. This correlation enables the GIS-based search engine to limit its search results to specific, user-defined geographic criteria.

In addition, the GIS-based search engine can be combined with real time advertising to create a dynamic “yellow page reference.” Thus, the search engine will not only provide the name, phone number, and/or address of the business, but it can also provide additional information on the business. In other words, the search engine can provide layered information such as advertising for the business. The advertising can vary from a simple text line to a full Web page ad, depending on needs or desires of the business. Further, the business can update the advertisements as often as it likes by uploading real time information to the databases used by the GIS search engine.

As used herein, the following terms have the following associated definitions: “Computer network(s)” or “network(s)” means any wired and/or wireless network, including global computer networks, local area networks, wide area networks, and virtual private networks, public switched networks and/or any combination thereof. “Entity” or “entities” means any business; government, non-government, or quasi-Government agency; person; and/or non-profit or for-profit organization. “Geometric corridor(s)” means any irregular or regular shaped polygon. “Information” means any numeric, alphanumeric and/or symbolic data, including analog and/or digital audio and/or video data, collected or included in, or data related to the data collected or included in, a database. “Search engine(s)” means any localized and/or distributed computer software used for data searching information. “Search result(s)” means any result obtained by a search engine, including no matching information.

### BRIEF SUMMARY OF THE INVENTION

In accordance with one aspect of the present invention, a method for providing one or more geographically defined search results in response to a client query includes: receiving a geographically defined query from a user over the network; searching a geographic information database and an information system database for information corresponding to the geographically defined query; and outputting to the network, one or more search results derived from said searching.

According to another aspect of the invention, geographically defined user queries may be composed by the client using textual information and/or spatial search information. Spatial search information may be selected, e.g., by the user highlighting a desired point or area on a displayed map. A combination search including text and spatial information may also be used.

In accordance with another aspect of the present invention, after searching, the method further includes sorting search results according to a specified criterion. In certain embodiments, the specified criterion may be user selected or specified by program parameters to include criterion such as: (i) proximity of geographically defined query; (ii) closest information result, e.g., matching searched name; and/or (iii) advertising information associated with query. Additionally, the outputted search results may be displayed to the user according to various display options corresponding to the sorting criterion.

In accordance with another aspect of the present invention, the method further includes outputting advertising information with the one or more search results.

In accordance with another aspect of the present invention, the method further includes updating the outputted advertising information to provide dynamic advertising.

In another aspect of the present invention, a method for associating a geocoding system coordinate with a search criteria utilizing a search engine associated with a geographic information system database and an information database, includes: receiving a query from an associated user, searching for at least one search result, identifying the at least one search result corresponding to a specified geographic area, and providing the at least one identified search result to the associated user.

In yet another aspect of the present invention, the method may also include: identifying multiple search results corresponding to the specified geographic area, and sorting the search results utilizing at least one sorting criterion selected from the group comprising: distance from a selected geographic location, time, price, and alphabetical order, and wherein the query is at least one entity criterion chosen from the group comprising name, brand name, product type, product category, service name, service category, business name, event, event forum, price, time, and/or combinations thereof. In certain embodiments of the invention, the specified geographic area is selected from the group comprising distance from a zip code, distance from an area code, distance from a telephone exchange area, distance from a state, distance from longitudinal and latitudinal coordinates, distance from state planar coordinates, a geometric corridor, distance from a unified geocoding system coordinate, and/or combinations thereof.

In a further aspect of the present invention, the method further includes providing advertising data for an entity to the associated user, and in certain preferred embodiments, the provided advertising data corresponds to an entity or entities identified in the search result(s).

Another aspect of the present invention includes the advertising data being chosen from the group comprising text, a graphic image, sound, a banner, a web page, and/or combinations thereof.

In accordance with another aspect of the present invention, the method includes receiving information for the information database from either a third party or from the entity or entities, providing registering means for registering a geocoded user preference profile, providing notification to the associated user when an event matches the preferences profile, updating event schedules, targeting event notifications to at least one specified geographic area, assigning relevance to each of the search results, and arranging the results in order of relevance.

Yet another aspect of the present invention includes a computer readable medium containing machine-readable code for enabling a client, host and server system to perform the methods described herein.

### BRIEF DESCRIPTION OF THE SEVERAL VIEWS OF THE DRAWING

Further aspects, features and advantages of the present invention will become apparent from the following description of the invention in reference to the appended drawing in which like numerals denote like elements and in which:

FIG. 1 is a functional block diagram illustrating an example GIS-based search system according to one preferred embodiment of the invention;

FIG. 2 is a flow diagram illustrating method of operation of a GIS-based search system according to one embodiment of the present invention;

FIG. 3 is a table including example information that may be included in a database for a GIS-based search system; and

FIG. 4 illustrates an example HTML representation of a search result returned produced by a GIS-based search system according to one embodiment of the invention.

### DETAILED DESCRIPTION OF THE INVENTION

A GIS-based search system according to one embodiment of the invention generally includes a three-tier client/server system including: (i) a mapping/database layer; (ii) a client layer; and (iii) an application and business/logic layer.

The mapping/database layer functions to host and store search information including geographic information and general information. It provides GIS and database functionality to output results, over a host network, to the client layer under direction and/or in cooperation with the application and business/logic layer. The mapping/database layer may be used to correlate client spatial search requests with unified geocodes or other geographical records and provide matching business or other information under the direction and control of the application and business/logic layer.

The client layer functions to provide the interface for the client to query the system and display search results on the client's side.

The application and business/logic layer functions to handle communications between the client layer and the mapping/database layer, control GIS-based search application functionality, and store and track defined business rules and/or other application program parameters. The application and business/logic layer provides the primary control aspects of the system such as directing text and/or spatial search requests based on inputted information from the client layer, parsing information for database queries, sorting search results according to defined parameters and formatting information, such as map displays, advertising graphics, and/or other search defined information, for output to the client layer.

Application and business logic layer may be configured from any software residing on any single device, combination of devices or shared device that is capable of for performing the functions described herein. The application and business logic layer preferably utilizes a server based programming language that supports HTML, native and/or open database communication (e.g. Oracle OCI, or ODBC respectively), and programmatic gateways to standard interchanges (e.g. CGI, Java) and third party APIs. In a preferred embodiment the application and business logic layer is configured to perform functions described herein using a tag-based programming language capable of integrating web-based scripting with logic from predefined templates. Macromedia's Coldfusion, SUN Microsystems J2EE in a JavaServer Pages (JSP) implementation, WebObjects (Apple-based development suite) and/or similar application development programs and tools may be used to implement the application and business logic layer.

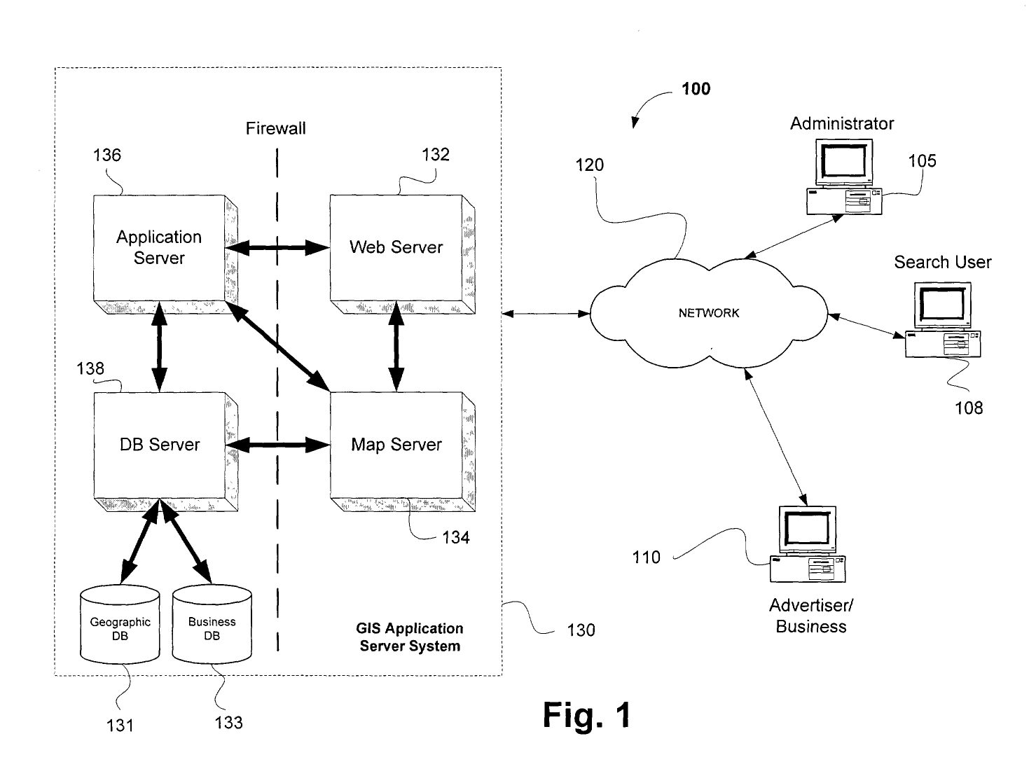

Turning to FIG. 1, an example implementation of a GIS-based search system 100 preferably includes one or more client terminals 105, 108 and 110, a network 120 in communication with the client terminal 105, 108 and 110, and a GIS application server system 130 in communication with network 120.

Client terminals 105, 108 and 110 serve the purpose of communicating with the GIS application server system 130 through network 120 to provide client side interfaces such as a user search interface (e.g., using terminal 108), database information update interface (e.g. using terminal 110), and/or server or site administration interface (e.g. using 105). Client terminals 105, 108 and 110 may be any processing device capable of communicating with server system 130 over network 120, such as desktop or laptop PCs, PDA's, cell phones, private network servers, and so on. Client side interfaces for terminals 105, 108 and 110 are preferably capable of utilizing commercially available web browsers such as Internet Explorer or Netscape. In preferred embodiments, the client side interface uses a web-based browser in association with mapping client for providing dynamic mapping displays as discussed in further detail hereinafter.

Network 120 may be any wired, wireless, packet-switched or dedicated line communication network or combination thereof. In one preferred implementation, network 120 is the Internet or an intranet.

GIS application server system 130 functions to receive, process and output user search requests (including associated geographical search, result and display information) and store/update information databases. Application server system 130 can be any computing device, combination of devices or shared device operative to provide the functions described herein. In one preferred implementation server system 130 comprises a plurality of servers including web server 132, map server 134, application program server 136 database server 138 and corresponding information databases 131, 133.

The term “server” may refer to both the hardware and software (the entire computer system) or just the software that performs the service. Consequently, servers 132, 134, 136 and 138 may each be individual machines each running separate software, a single machine including software for performing the separate server functions or any combination of devices and software platforms operative to perform the functions described herein. Information database 133 and the GIS database 131 can either be interdependent or independent of each other and could be stored in association with map server 134, database server 138 and/or a combination thereof. Any combination of databases and database types can be used.

Web sever 138 facilitates the network interface between client terminals 105, 108 and 110 and application 136, mapping 134 and database 138 servers over network 120. Web server 138 may be any single device, combination of devices or shared device (including a web server separately hosted by an ISP) including software capable of accomplishing these functions. In one preferred embodiment, web server 138 is a single processor (e.g., Intel based processor) computer with web serving software such as commercially available web server software from, for example, Apache, Microsoft, Zeus and/or iplanet.

Map server 134 may be any single device or combination of devices including software for providing the network based GIS functionality described herein. In one preferred embodiment, map server 134 is a dedicated RISC-based processing machine such as an IBM Pseries or Sun Microsystems Enterprise series, running map server software such as AutoDesk MapGuide, Mapinfo MapXtreme, ArcIMS (Internet Map Server).

Map server 134 (through client browser interface and under application program control) enables the selection of features (geographic points or areas) in geographic database 131 and finding of geocoded records from information database 133 that are, for example, (i) pointed to, (ii) within a specified distance from other selected features; (iii) within other selected features; (iv) within a user specified area; (v) outside of selected features; (vi) outside a user specified area; (vi) beyond a specified distance from other select features; and/or (vii) are within multiple selected and user defined areas satisfying Boolean logic search requests, e.g., AND, OR and XOR. The map data (and view at the client side browser) can be changed based on user specified pan and zoom level and areal extent of selected features. Map server 134 may also be capable of turning map view layers on and off as well as geocode records within information database 133 based on consistent projection and datum standards.

Application server 136 may be any single device, combination of devices, or shared device including software for providing the application and business logic layer functionality described herein. In one embodiment, application server 136 is a single or two-processor (e.g., Intel based processor) machine to control application processing and communications between web server 132, map server 134 and database server 138 as defined by application and business logic layer software, which may be resident on server 136.

Database server 138 may be any single processing device, combination of processing devices or shared device including database management software operative to access, manage and/or store one or more information databases (e.g., databases 131 and 133). In one embodiment, to accommodate multiple user high bandwidth search applications, database server 138 is preferably a dedicated RISC-based processing machine such as an IBM Pseries or Sun Enterprise series server machine and software, including a DataBase Management System (DBMS) and databases, capable of maintaining records including spatial data, for example, Oracle9i Spacial, IBM DB2 Spatial Extender, or Informix Spatial DataBlade.

Geographic information database 133 may be resident on any single device, combination of devices, or shared device including software capable of storing searchable geographical information. In preferred embodiments geographic database 133 (i) may be queried by the GIS at the record level by location or attribute; (ii) can store appropriate data for correlating spatial searches such as transportation routes (e.g., streets, highways, transit lines), political boundaries (e.g., city, county, state, country), points of interest (e.g., schools, hospitals churches, museums, and bus stops), and/or areas of interest (e.g., universities, golf courses, parks). Loaded data may be in the same projection (e.g., geodetic, UTM, state plane) and the same datum (e.g., NAD27, NAD83).

General information database 131 (interchangeably referred to herein in a non-limiting manner as “information” “business” or “business information” database 131) may be resident on any single device, combination of devices and/or shared device including software capable of storing searchable information about entities. Information database 131 may preferably be queried by map server 134 and/or application server 136. Information database 131 may be access limited defined by user specific security roles and can preferably support multiple user connection and queries. In preferred embodiments, each record in database 131 includes a unique identifier that may be cross-referenced by other databases (e.g., geographic database 133). Database 131 is preferably capable of storing data records including geocodeable data elements (e.g., address, ZIP codes) and/or predefined geocodes (e.g., geodetic, state plane, and/or UTM) as well as requisite business information (e.g., name, business type, classification, home page URL, advertising information).

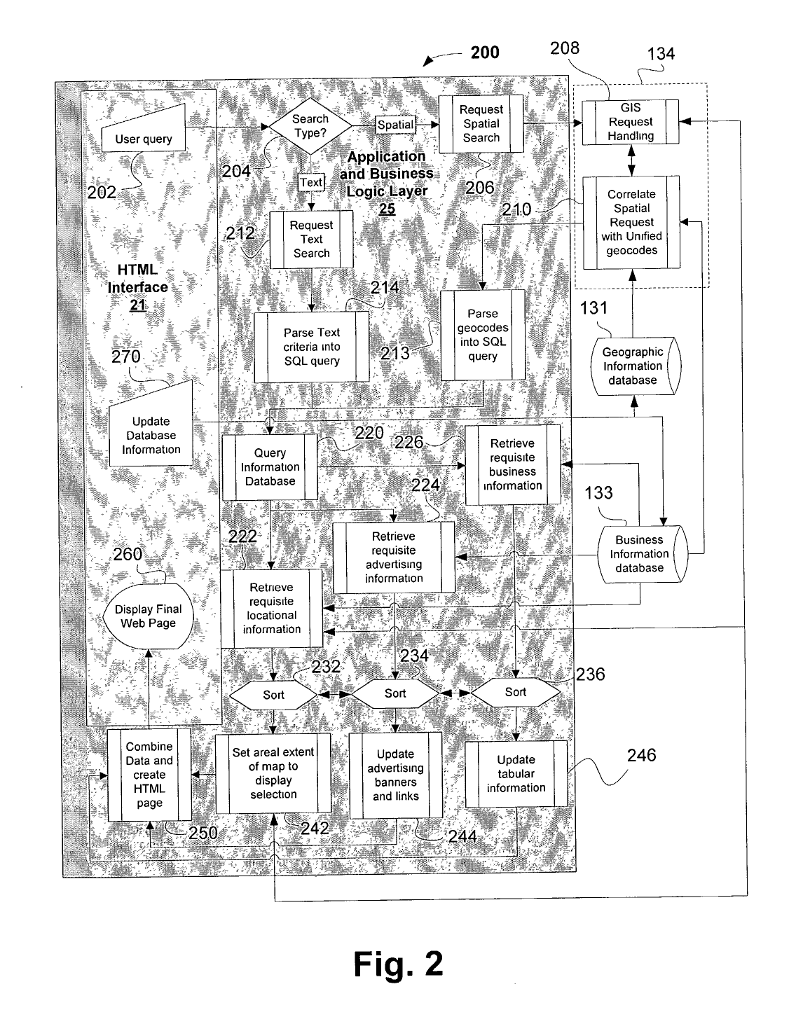

Turning to FIG. 2, a method of operation 200 for GIS-based search system 100 will now be described. For a client initiated search, a user may compose and submit a query (step 202) including geographical search criteria using textual and/or spatial parameters through, for example, HTML interface 21 with application server system 130 (e.g., between client terminal 108 and web server 132; FIG. 1).

User query (step 202) may be submitted to the search engine via a computer, a kiosk, voice recognition telephony, touch screen, wireless device, or any other technology which will act as an interface between terminals 105, 108 and/or 110 and network 120. User query 202 may preferably include (i) location data, (ii) a general information query (e.g., subject matter desired), and/or (iii) geographic criteria.

Location data may typically provide information on the user's geographic location, destination or area of interest. However, location data can be any geographic reference location chosen by the user. In one preferred embodiment, the location data is based on a unified geocoding system, but the location data can be any type of longitudinal and latitudinal coordinates, geometric corridor, state planar coordinates, zip code, address, or any other known geographical reference information.

The general information query may include one or more criterion about a particular entity or type of entity such as: a business name, category of business, a specific GIS location, a product name, a brand name, a service name, pricing criterion, a time criterion, an event criterion, a service category, or combinations thereof. The information query can be any query that is correlated to information stored in an information database (e.g., database 133). A user may even beguided, e.g., via HTML interface 21, as to the types of search information that may be inputted by a user. Such guiding may be performed, for example by an index of options provided in association with a displayed map. In one example a user may select an area on the displayed map, select a predefined index parameter, e.g., “Restaurants,” and start the GIS-based search.

Geographic criteria primarily define the involvement of the GIS database (e.g., database 131) in filtering the search results for the information query. For example, user query 202 can be limited to those results (e.g. businesses) that are located in a defined geographic area. For example, the geographic area may be a city, country, state, country, radial distance, or geometric corridor. Geographic criteria may also include the geographic area within a specified zip code, an area code, or the area defined by a specific radius from the location data, such as a street address, zip code, area code, state, longitudinal and latitudinal coordinates, any unified geocoding system, state planar coordinates, or combinations thereof. In addition, the search results can be limited and/or sorted to those results that are in closest proximity to the location data. For example, if the user enters or spatially designates his home street address as the location data, then he can request that the ten search results in closest proximity to his home be provided.

User query 202 is communicated via network 120 (FIG. 1) to application sever system 130 (e.g., via web server 132) where the application and business logic layer 25 (e.g., resident on application program server 136) determines if the query includes text and/or a spatial search parameters (step 204). Application and business logic layer 25 preferably includes routines that (i) requests the user to enter textual search criteria based on address, business name/type, postal code or other text fields that may exist in database 133 (step 212) and/or (ii) select and/or draw features, e.g., from a user displayed map, and/or specify a distance criteria, for defining the spatial search criteria (step 206).

If the client query includes a spatially defined parameter (step 206), a spatial search request is composed and forwarded by the application and business logic layer 25 to the GIS (e.g., map server 134, DB server 138 and information from geographic database 131) where the request is handled (step 208) and processed (step 210) to determine corresponding unified geocodes, and/or other matching geographic reference information correlating to the spatially defined search criteria.

The resulting geocodes and/or other geographic reference information, along with any text search information from the user query (step 212), is then used for querying one or more general information database(s) (e.g., database server 138 and business information database 133) to find records matching the geographic reference and/or text search information (step 220). In one preferred embodiment for a spatial search, corresponding geocodes are parsed into an SQL database query along with other information fields, for example, subject matter of the search (steps 213 and 214). The SQL query is used to search a database (e.g., business information DB 133) for records that have a matching geocode and/or other information fields. Matching records are then provided and/or displayed to the user (e.g., via HTML interface 21) (steps 250 and 260).

According to certain aspects of the present invention, database query (step 220) may identify matching records from database 133 including location information (step 222), advertising information (step 224) and/or business information (step 226) related to user query 202.

Location information may include extracting geocodes from search results in database 133 for repopulating point features in the user's browser map using, e.g., mapping server 134 and database 131 (step 222).

Information database 133 can also optionally be associated with online advertising content, advertising databases, or links to other web sites. This type of information may be associated with certain records of entities in the database so that, for example, a search for auto part stores in a certain location might return associated advertising information about auto part retailers who advertise with the GIS-based search engine provider.

Advertising information may include, without limitation, information stored on an advertising database (apart from, or integrated with, information DB 133), links to associated web sites, information stored within the information database, and information stored on system server 130 (FIG. 1). Thus, businesses may have the option of having not only their name and/or contact information (e.g. business information) submitted to a user in response to user query 202, but also additional advertising information. For example, the advertising information could include text, such as a written description of the company, its products and/or services, a banner ad, and any specials or coupons offered by the business, graphic images, or sounds, such as aural advertisements or music.

In one embodiment of the invention, an advertiser may remotely update advertising information (e.g., using terminal 110; FIG. 1). In other embodiments, promoters or producers of special events (concerts, air shows, exhibitions, community events, etc.) may have the option of advertising an event utilizing the GIS-based search engine. For example, users may search for specific or generalize events to be held within a specified geographic region of interest and/or within a specified time frame of interest.

In additional embodiments, users are provided with the capability of registering a geocoded user preference profile with the GIS-based search engine, information database, and/or an advertising database. This may enable advertisers and/or others to target information to the user based on his or her geographic location. For example, to be used in providing automatic e-mail notification (or notification through any electronic notification system distributed through a computer network) on banner advertisements, etc., when an advertised event matches the specifications contained in the geocoded user preference profile. Advertisers may also have the ability to target their event notifications to users located in specific geographic areas.

Business information, e.g., business attributes such as name, address, goods, services, hours, and contact information, is extracted from database 133 (step 226) for display using interface 21.

Any of these types of matching information may subsequently be sorted according to user preference and/or a predefined search result sorting routine. Such sorting may pertain to specific sorting criteria, for example, by order of importance, relevance or hierarchy of the information retrieved from database 133. Example sorting criterion might include, a distance from the user identified location (e.g., step 232), corresponding advertising information (e.g., step 234) and/or business information (e.g., step 236). Business information may be sorted according to various criteria, for example, alphabetical criteria, such as by the name of the business, size criteria, such as the size of the business, price criteria, time criteria, event criteria, or any other sorting criteria that might be helpful to a user.

Method 200 may further include arranging the sorted information for display to the user. Such arrangement of information may include defining an area of a map for display, and/or highlighting one or more entities identified in the search results on the displayed map (step 242), updating banners and links for advertisements (step 244) and/or updating/organizing information about each entity matching the user query (step 246). The foregoing information may be combined in any presentable format (step 250), e.g., using HTML and/or web scripting applications, and displayed to the user (step 260).

Another feature of the invention is the capability for the GIS-based search engine to display and dynamically update a user map according to the location and/or distance of searched entities. For example, if the user query (step 202) included steak houses near a desired map location, and one or more matching records of the search result did not fall within the currently displayed user map region, the area of displayed map may be updated (automatically or upon user selection) to accommodate the returned result within the displayed map region (step 242). By way of example, if application and business logic layer 25 determines that any location information search results include geocodes or geocode reference points outside of the presently displayed map, it (automatically or upon user notification and request) interfaces with map server 134 to reconfigure or extend the map view accordingly.

Method 200 may further include the capability for an administrator and/or other entity (e.g., a business registered with the GIS search engine provider), to update information stored in information database 133 and/or potentially GIS database 131, from a remote terminal (e.g., 105, 108 and/or 110; FIG. 1) over network 120 (step 270). For example, if a restaurant wanted to update its business information in database 133, the restaurant representative could preferably access the database and, for example, change the menu, phone number, address and/or other information associated with its database records. Geographic information, such as geocodes pertaining to the restaurant's locations might also be remotely added, deleted or otherwise updated in database 133. However, in one preferred implementation of the invention, application server 136 and database server 138 including corresponding databases 131 and 133 are protected from public access using for example, a network firewall (FIG. 1) and/or other network security feature.

Information database 133 may be searched using any type of known database queries. In one preferred embodiment the information (e.g., text and or spatial) is parsed into an SQL statement to find records matching the defined location, general information and/or geographic criteria. A user query may also input geographic reference information using only a text search (step 212) (i.e., without a spatial parameter). In this case, matching location information can be obtained directly from database 133 or with verification and/or collaboration from the GIS (e.g., at step 222).

Information database 133 preferably includes a business index comprised of record fields that correlate to the parameters of the search query. The business index preferably include fields that correspond to criteria, such as a business name, GIS location (e.g. unified geocodes and/or other geographic reference information), a product name, a brand name, a service name, and/or a service/product category. Each business record is preferably associated uniquely with a particular business or other entity.

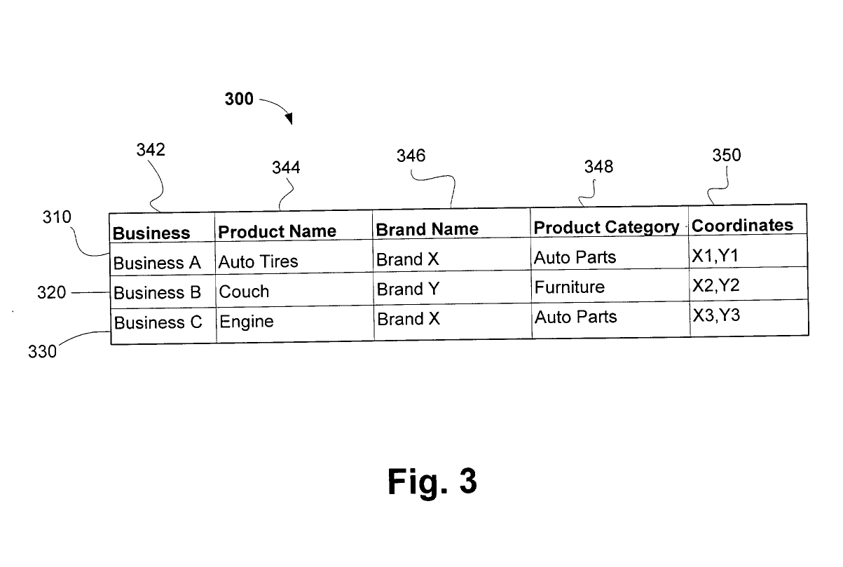

Turning to FIG. 3, an example business index 300 includes three records, 310, 320 and 330. In this example, each record 310, 320 and 330 includes five fields, including business name field 342, product name field 344, brand name field, 346, product category field 348 and a GIS location field (geographic reference information field) 350. A user can search for any entity criterion that is correlated to business index 300. For example, if the user searched for Brand X, since both Business A and Business B include Brand X in their respective product name field 344, both of these businesses may be identified in a database query (e.g., step 220; FIG. 2). However, if the user searched for a couch, only Business B would be identified. Alternatively, if the user searched for automobile tires and automobile parts in the product category field, only Business A would be identified. Business index 300 is described and shown only as one example for information and/or database record storage and is not intended to limit the scope of this invention in any manner. Any known manner for storing, indexing and searching information in a database, which facilitates the storage of pertinent user search information and/or corresponding geographic reference information could be used.

Information for business index 300 may be obtained from a third party, for example, advertising companies, government agencies, business credit bureaus, yellow page providers, telecommunications companies, marketing companies, etc. In certain embodiments, these entities will pay a fee, or other type of compensation, to list its clients and/or associated goods or services on database 133.

Each record 310, 320 and 330 in index 300 preferably includes a geocode or other geographic reference information field 350 having the same type of geocode format as the GIS database (e.g. database 131). Alternatively, and/or in addition, a unique identifier unrelated to the entity criteria or the geographic criteria can be used. However, the description of database records and indices are only examples that might be used and are not intended to limit the scope of this invention in any manner.

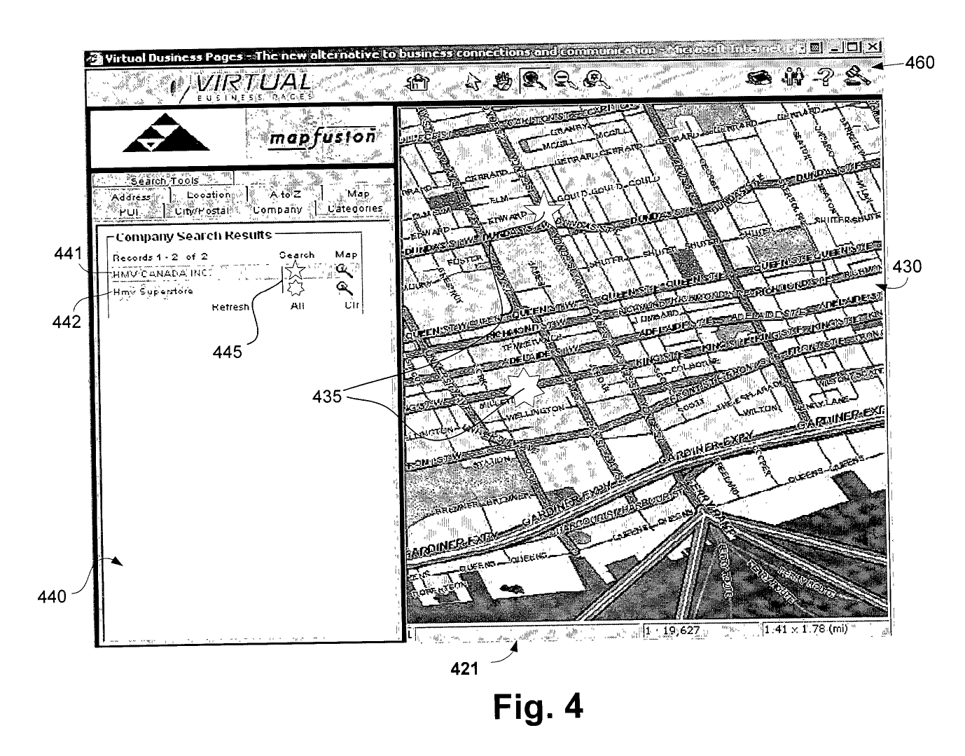

Turning to FIG. 4, an example interface 421 (e.g., HTML interface 21) with a GIS-based search system preferably includes a geographic reference portion 430, a text information/search portion 440 and preferably, one or more tool bars 460.

Interface 421 is one example of a graphic user interface (GUI) for client/server interface with, e.g., application server system 130 (FIG. 1). Geographic reference portion 430 preferably serves the purpose of enabling a user to define a spatial search parameter, for example by highlighting a portion of a displayed map using a mouse or other GUI tool. Geographic reference portion 430 also preferably serves to visually identify relative locations of one or more search results retrieved from the search system database on a displayed map.

Geographic reference portion 430 is preferably implemented using a web browser such as Internet Explorer and a mapping client, e.g., a frame built on the client browser by application and business logic layer 25 using HTML and Java Script applications. The mapping client enables the browser to communicate with a mapping server (e.g., server 134) to display specific maps in the geographic reference portion 430 using the HTML and JavaScript from application and business logic layer 25. In preferred embodiments, a displayed map may be scrolled, zoomed or otherwise manipulated in geographic reference portion on substantially a real-time basis to result in a dynamic map display.

In preferred embodiments, if the client browser does not support the geographic reference portion 430 (e.g., does not include the mapping client), either a map will not be displayed in geographic reference portion 430, a static map will be displayed, or the frame for geographic reference portion 430 will not be displayed at all. Alternatively, the browser may be redirected to download a mapping client plug in from the map server to facilitate interactive map features.

Text information/search portion 440 servers the purpose of enabling the user to input text search terms, select sorting criterion, and/or view information or categories of information associated with search results. In a preferred embodiment, these features and information may be displayed to the user in a tabular form; however, any presentation format associated with exchanging information in a graphic user interface may also be used.

Tool bar portion 460 enables a user to perform desired actions through the GUI. Standard actions such as zoom in, zoom out, new search, print map, print information, help and other typical toolbar features may be facilitated using tool bar portion 460.

As shown in the example web interface of FIG. 4, a user query of HMV music stores in a user defined area, returned two search results 441, 442. The locations of search results 441 and 442 are shown by corresponding indicia 445 in text information portion 440 and indicia 435 on the map displayed in geographic reference portion 430. In one embodiment, when a user selects the appropriate option, e.g., clicking on indicia 435, 445 or other available select option area, additional textual information may be presented, e.g., in place of, in a pop up frame near, or an adjacent frame proximate, the map displayed in geographic reference portion 430.

In one exemplary embodiment, the application and business logic layer software is configured to include one or more of the following features:

A routine that requests the user enter textual search criteria based on address, business name/type, postal code or other text fields that may exist in Information database 133 alternatively referred to as the Business Information Database (BID).

A routine that parses the text search criteria and formats it as an SQL query.

A routine that requests the user to select and/or draw features from the geographic information database (GID) and/or specify a distance criteria that specify a spatial search criteria.

A routine that extracts the exterior hull of the spatial request and overlays it with the geocoded records of the BID and returns BID unique business identifiers.

A routine that formats the unique business identifiers into an SQL statement.

A routine (15) that combines, if required, text requests and spatial requests into a single SQL statement that is executed against the BID.

A set of routines that respectively:

i) Extract banner advertising information and URL links from the BID pending for browser display, alternately external advertising and URL information can be retrieved from external sources based on metadata in the BID records;

ii) Extract geocodes from the BID and repopulates point features in the browser map via the GIS; and/or

iii) Extract business attributes from the BID pending for browser display

A routine that sorts business records from the BID based on user criteria (e.g., distance from selected geographies, time, inventory volume, sale price etc)

A set of routines that respectively:

i) Set the extent of the browser map via the GIS based on the new features returned from the database query;

ii) If necessary, update the advertising banners and URL links; and/or

iii) Update tabular BID information based on the new features returned from the database query.

A routine that combines retrieved and sorted information into a properly formed HTTP web page based on current user browser window size.

A routine that permits authorized users to updating of BID records.

Unless contrary to physical possibility, the inventor envisions the methods and systems described herein: (i) may be performed in any sequence and/or combination; and (ii) the components of respective embodiments combined in any manner.

The skilled artisan will understand that the specific architectures, processes and software configurations described above could be varied without departing from the scope of the invention. Consequently, although there have been described preferred embodiments of this novel invention, many variations and modifications are possible and the embodiments described herein are not limited by the specific disclosure above, but rather should be limited only by the scope of the appended claims.

What is claimed is:

1. A method of providing information search results over a communications network, the method comprising:
receiving a user query over the network, wherein the user query includes a general information part and at least one geographic criterion;
searching stored information for information pertaining to the general information part and conforming to the geographic criterion;
identifying one or more search results based on the searching of stored information; and
sending the one or more search results to a user.

2. The method of claim 1 wherein the geographic criterion comprises unified geocodes.

3. The method of claim 1 wherein sending the one or more search results includes sending text information and graphic display information to the user for each search result identified.

4. The method of claim 3 wherein the graphic display information comprises map data and search result location indicia corresponding to the map data.

5. The method of claim 1 wherein searching comprises:
comparing the general information and geographic criterion to information stored in at least one database.

6. The method of claim 5 wherein identifying comprises
locating one or more matching records based on the comparisons; and
sorting the located one or more matching records according to a predefined sorting criteria.

7. The method of claim 6 wherein the predefined sorting criteria include at least one criterion selected from the group consisting of location criterion, advertising criterion, and business criterion.

8. The method of claim 7 wherein a user selects the predefined sorting criteria.

9. The method of claim 1 wherein the geographic criterion comprises spatial data.

10. The method of claim 9 wherein the spatial data is selected by a user from a user displayed map.

11. The method of claim 1 wherein the geographic criterion comprises text data defining a geographic location.

12. The method of claim 1 wherein the stored information comprises a first type of information for interpreting the geographic criterion of the user query, and a second type of information including records having references to the first type of information.

13. The method of claim 12 wherein the first type of information comprises unified geocode information.

14. The method of claim 1 wherein the network comprises an Internet.

15. The method of claim 1 wherein sending one or more search results to the user comprises:
sending a first component related to the general information part of the user query; and
sending a second component including advertising information, wherein the advertising information is related to at least one of the geographic criterion of the user query and the general information part of the user query.

16. A method of hosting communications between a client and a server for a GIS-based search engine, the method comprising:
facilitating electronic transfer of a user query between a user and a search system provider, the user query comprising a general information part and at least one geographic criterion;
facilitating electronic transfer of at least one search result between the search system provider and the user, wherein the at least one search result comprises information pertaining to the general information part and conforming to the geographic criterion.

17. The method of claim 16 wherein the at least one geographic criterion comprises spatial data selected by a user from a displayed map.

18. The method of claim 16 wherein the general information part comprises text data.

19. The method of claim 16 wherein facilitating electronic transfer of the user query comprises enabling the client to communicate with the server over a global distributed computer network.

20. A method of advertising to a specific geographic audience using a network search engine, the method comprising:
providing advertising information for access by the network search engine, wherein said advertising information includes a geographical reference tag, said advertising information being delivered to a user when a user query includes information corresponding to said geographical reference tag.

21. The method of claim 20 wherein the geographical reference tag comprises one or more unified geocodes.

22. A method of retrieving search results from a search engine over a communications network, the method comprising:
composing a user query including a general information portion and a geographic criterion portion;
sending the user query to the communications network; and
receiving at least one search result, in response to sending the user query, said at least one search result comprising information pertaining to the general information portion and corresponding to the geographic criterion portion.

23. The method of claim 22 wherein composing the user query comprises:
designating a geographic location for which the at least one search result is desired; and
identifying a subject matter for the general information portion.

24. The method of claim 23 wherein designating the geographic location comprises selecting a spatial location on a user displayed map.

25. The method of claim 24 wherein identifying the subject matter for the general information portion comprises at least one of, entering or otherwise inputting text defining the subject matter and selecting from an available list of subject matter.

26. An application server system comprising:
at least one processor capable of executing instructions set forth in a machine readable code;
at least one memory communicatively coupled to the at least one processor, said memory storing, temporarily or permanently, a compilation of machine readable code, that when executed by the at least one processor, is operative to:
receive a user query comprising a general information part and at least one geographic criterion;
search stored information for information pertaining to the general information part and conforming to the geographic criterion;
identify one or more search results based on the searching of stored information; and
send the one or more search results to a user.

27. The system of claim 26 wherein the geographic criterion comprises one or more geocodes.

28. The system of claim 27 wherein general information part comprises search subject matter data.

29. The system of claim 26 wherein the one or more search results comprises map data and text data.

30. The system of claim 29 wherein the one or more search results further comprises advertising data.

31. The system of claim 30 wherein the advertising data is associated with the at least one geographic criterion.

32. The system of claim 26 further comprising a first database storing geographic information and a second database storing entity information.

33. The system of claim 26 wherein said at least one processor is capable or being communicatively coupled to an Internet.

34. The system of claim 26 wherein the compilation of machine readable code is further operative to:
enable a client graphic user interface to view at least one map.

35. The system of claim 34 wherein the compilation of machine readable code is further operative to:
dynamically update the at least one map on the client graphic user interface.
